(19) United States
(12) Patent Application Publication
(10) Pub. No.: US 2025/0262522 A1
(43) Pub. Date: Aug. 21, 2025

(54) EZLOTTO Transparent Digital Raffle System Based on Fixed-Value Ticket Aggregation

(71) Applicant: Ammar Alsalih Altaheni, Essen (DE)

(72) Inventor: Ammar Alsalih Altaheni, Essen (DE)

(21) Appl. No.: 19/187,809

(22) Filed: Apr. 23, 2025

(51) Int. Cl. A63F 3/08; G06Q 30/0201; G07C 15/00

(52) U.S. Cl. CPC A63F 3/081; G06Q 30/0206; G07C 15/006; A63F 2003/082

(57) ABSTRACT

A system and method for conducting transparent digital raffles using a fixed-value ticket aggregation model. The system employs a mathematical balance principle ensuring the total value of sold tickets equals the declared market value of the raffled product. Key components include: a value balance mechanism maintaining the equation (Ticket Price×Total Tickets=Product Value); a probability adjustment system enabling different ticket pricing configurations while preserving value equivalence; an over-sale prevention mechanism; an automatic refund system for incomplete raffles; and a verifiable random selection process that triggers only after all tickets are sold. The system incorporates security measures including encrypted data storage, transaction verification, and cryptographic proof of randomness for draws, creating a legally-compliant alternative to traditional raffle systems.

### DESCRIPTION OF THE INVENTION

This invention relates to a digital system and method for managing transparent, fair, and legally compliant item-based raffles, utilizing a mathematical balance principle between product value and ticket sales, incorporating mechanisms to ensure fairness, transparency, and regulatory compliance.

Traditional online raffle systems suffer from multiple issues: lack of transparency in product valuation, unclear probability structures, and absence of refund guarantees, making them unfair to users and similar to gambling operations. Current electronic lottery systems typically operate on a revenue model that relies on selling tickets at prices higher than the proportional value of prizes, creating an inherent imbalance that favors the operator at the expense of participants. Additionally, existing systems often fail to provide verifiable randomization methods, do not guarantee refunds for incomplete raffles, and lack transparent mechanisms for determining odds and ticket prices. This invention aims to address these problems through an innovative system that ensures complete balance between product value and total participant contributions.

The proposed system is an integrated digital platform that organizes raffles for physical products according to the following principles:
First, the Value Balance Principle: The fundamental equation governing the system is (Ticket Price×Total Number of Tickets=Declared Market Value of the Product).
Second, the Probability Adjustment Mechanism: The system allows modification of ticket numbers and prices while maintaining the fundamental equation, enabling different probability structures.
Third, the Over-Sale Prevention Mechanism: The system ensures that tickets are not sold beyond the total value of the product.
Fourth, the Automatic Refund Mechanism: If all tickets are not sold within a specified timeframe, the system automatically cancels the raffle and refunds all participants.
Fifth, the Transparent Drawing Mechanism: Use of a documented randomization algorithm to determine the winner after all tickets are sold.
Sixth, the Digital Ledger System: The implementation of a secure digital record-keeping system that tracks all transactions, ticket assignments, and draw results for auditability and transparency.

The Core System Components include:

The User Interface (UI) features a homepage with current raffles, search & filtering capabilities. The product page displays: product image and description, market value of the product, ticket price, total number of tickets, remaining tickets available, calculated probability (1 in X chance), and countdown timer or status indicator. The system includes a checkout system for ticket purchase with secure payment processing, user dashboard (active tickets, past raffles, wins, refunds), notification system for raffle status updates, and digital ticket representation with unique identifiers.

The Admin Interface includes a raffle creation module with fields for: product information entry, value declaration, ticket pricing configuration, total ticket quantity calculation, and time limit settings. It also features a sales tracking dashboard with real-time analytics, payout and refund management system, draw management and audit logging, user management system, security monitoring tools, and reporting and analytics dashboard.

The Raffle Engine consists of a ticket management system with real-time inventory control, lock mechanism that activates when all tickets are sold, randomization algorithm utilizing verifiable random function technology, and winner selection and notification system. The draw trigger is strictly ticket-count based. Time-based elements may exist for UX or promotional tracking, but they do not control raffle execution. The engine includes a cryptographic verification system for draw integrity and audit trail generation for all system actions.

The Refund Manager includes a timer monitoring system for raffle expiration, automatic payment processing integration for refunds, transaction logging and user notification system, payment gateway integration with multiple providers, error handling and transaction verification system, and reconciliation system for tracking refund status.

The Legal Compliance Layer features an age verification system, regional access configuration based on geolocation, terms of service and policy display, adjustable time limits to comply with consumer protection laws, data protection mechanisms for GDPR compliance, identity verification protocols where legally required, and API connectivity for regulatory reporting where applicable.

The Security Framework provides encrypted data storage for user and transaction information, multi-factor authentication for administrative actions, API security measures with token-based authentication, rate limiting to prevent system abuse, intrusion detection system for unauthorized access attempts, and regular security audits and penetration testing procedures.

The Technical Process Flow includes several processes:

The Raffle Creation Process begins when the system calculates ticket quantities based on the formula: Number of Tickets=Product Market Value÷Ticket Price. The system validates that the calculation results in a whole number of tickets, creates database entry with raffle parameters and status, initializes ticket inventory with unique identifiers, generates cryptographic hash of raffle parameters for verification, validates product details and value against reference databases, and establishes refund parameters and timeframes.

The Ticket Sales Process involves the system verifying available inventory before processing purchase, processing secure payment through integrated payment gateway, assigning unique ticket identifiers to the user, updating inventory in real-time, preventing sales once maximum ticket count is reached, issuing digital receipt with transaction details, recording transaction in secure database with timestamp, updating user profile with purchased tickets, and validating transaction against fraud detection parameters.

The Raffle Execution Process starts with the system monitoring ticket inventory status in real-time. When all tickets are sold, system locks raffle from further sales, initiates randomization algorithm with multiple entropy sources, generates verifiable proof of randomness for the draw, selects winning ticket based on the random value generated, records all draw data including timestamps and method used, notifies all participants of the draw results, triggers winner fulfillment process, and creates publicly verifiable record of the draw results.

The Refund Process involves the system monitoring time elapsed since raffle creation. If deadline is reached without full ticket sales, the system changes raffle status to “Canceled”, initiates refund for all purchased tickets, sends notifications to all participants, logs all refund transactions, verifies successful completion of all refunds, generates refund report for audit purposes, and maintains transaction records for compliance requirements.

The Winner Fulfillment Process includes the system recording winner details and verification requirements, initiating secure verification of winner identity, tracking product shipment or delivery status, maintaining record of delivery confirmation, collecting winner acknowledgment of receipt, and closing raffle as “Completed” with full audit trail.

The Probability Tier Technical Implementation involves the system applying the formula: Ticket Price×Total Tickets=Product Value. The system offers preconfigured probability tiers: Standard Mode (maximum tickets, lowest price), Premium Mode (fewer tickets, higher price), and Custom Mode (administrator-defined configuration). The system validates all configurations against the fundamental equation, calculates and displays exact odds for each configuration, applies input validation to ensure mathematical accuracy, and records all configuration changes in audit log.

Example Configurations include:

For a €1,200 product:
Configuration A: 1,200 tickets at €1 each (1:1,200 odds)
Configuration B: 240 tickets at €5 each (1:240 odds)
Configuration C: 120 tickets at €10 each (1:120 odds)

For a €50,000 product:
Configuration A: 50,000 tickets at €1 each (1:50,000 odds)
Configuration B: 5,000 tickets at €10 each (1:5,000 odds)
Configuration C: 1,000 tickets at €50 each (1:1,000 odds)

Alternative raffle formats such as limited-time previews may be supported, provided that the main product draw adheres to full ticket sale requirements.

The Revenue Model Technical Implementation includes a Wholesale Margin Mechanism where the system database stores: retail value (displayed to users), actual acquisition cost (visible only to administrators), calculated margin percentage, product source information, cost breakdown structure, and margin validation controls.

The Sponsorship Integration features API connections to merchant systems, featured listing algorithm with weighted display preferences, tracking mechanism for sponsored placement performance, analytics dashboard for sponsor ROI measurement, automated reporting for sponsorship effectiveness, and dynamic pricing model for sponsored placements.

The Subscription Model Implementation includes tiered subscription management system, benefit allocation engine for subscribers, early access provision mechanism, exclusive raffle access controls, and subscription analytics and reporting.

Data Security and Integrity features include Secure Data Storage with encrypted database for all user and transaction data, secure storage of payment information compliant with PCI DSS, segregated data access based on role permissions, regular backup procedures with encrypted offsite storage, and data retention policies compliant with regional regulations.

Transaction Verification is achieved through digital signature for all ticket transactions, blockchain-inspired ledger for transaction immutability, duplicate transaction detection and prevention, audit trail for all data modifications, and time-stamping of all system events.

Draw Integrity is maintained through multiple entropy sources for randomization, public verification mechanism for draw results, independent audit capability for randomization process, cryptographic proof generation for each draw, and tamper-evident logs of draw execution.

The invention is further illustrated by the following drawings:

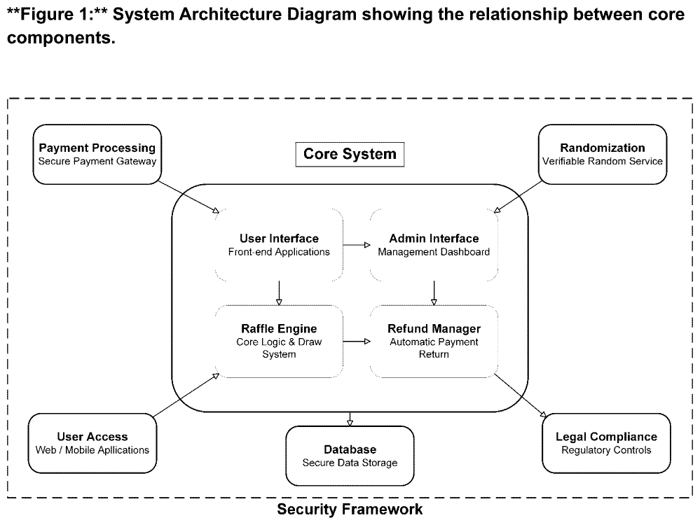

FIG. 1: System Architecture Diagram showing the relationship between core components.

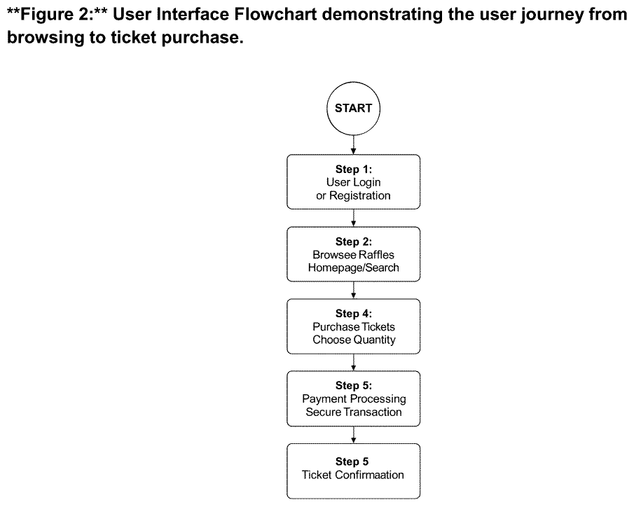

FIG. 2: User Interface Flowchart demonstrating the user journey from browsing to ticket purchase.

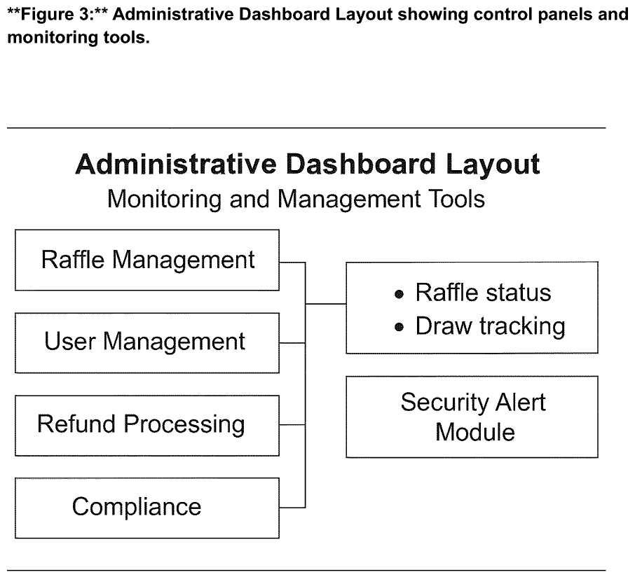

FIG. 3: Administrative Dashboard Layout showing control panels and monitoring tools.

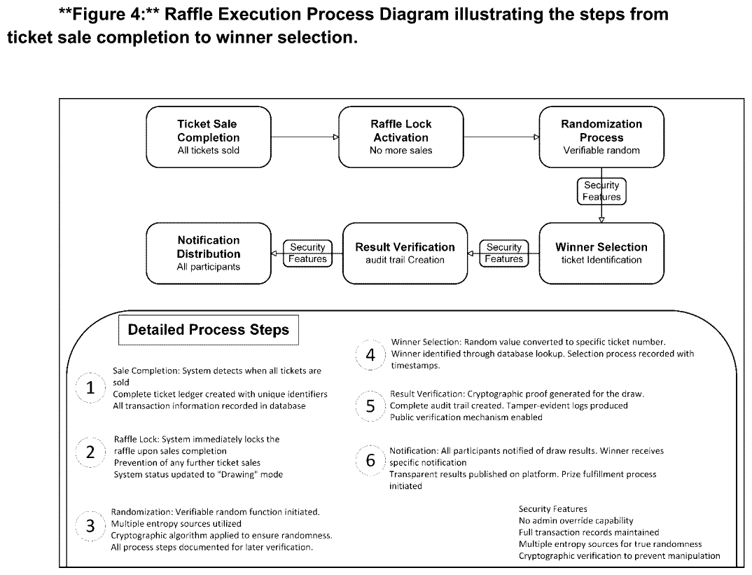

FIG. 4: Raffle Execution Process Diagram illustrating the steps from ticket sale completion to winner selection.

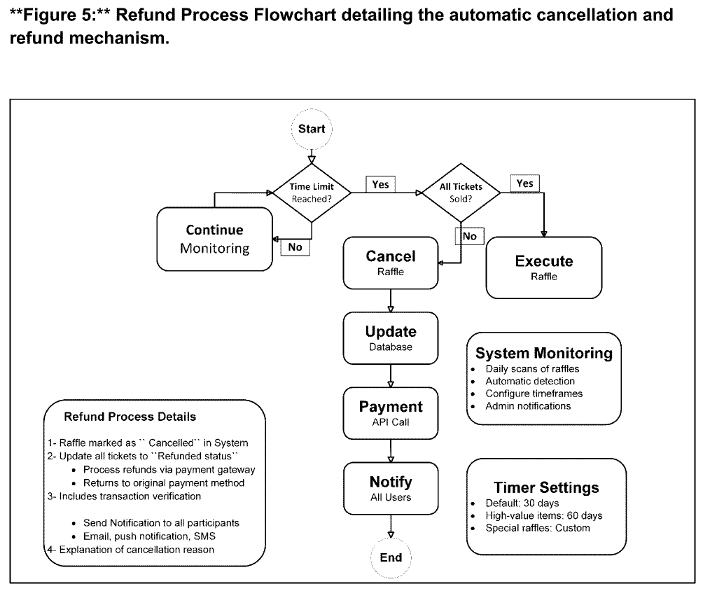

FIG. 5: Refund Process Flowchart detailing the automatic cancellation and refund mechanism.

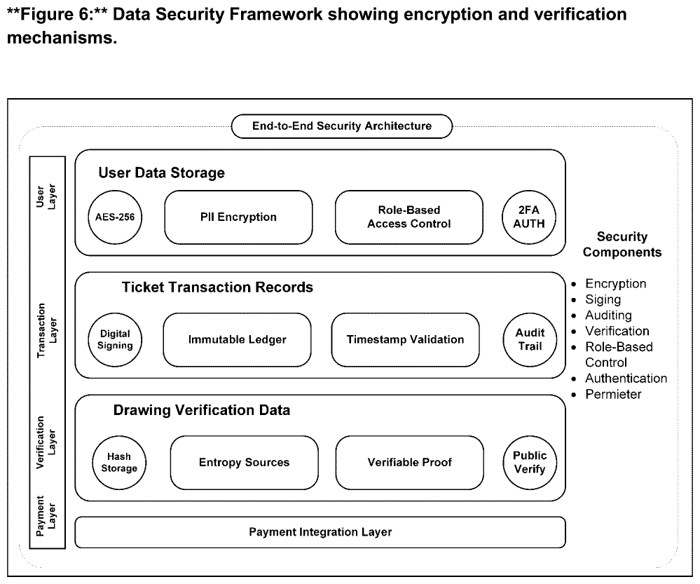

FIG. 6: Data Security Framework showing encryption and verification mechanisms.

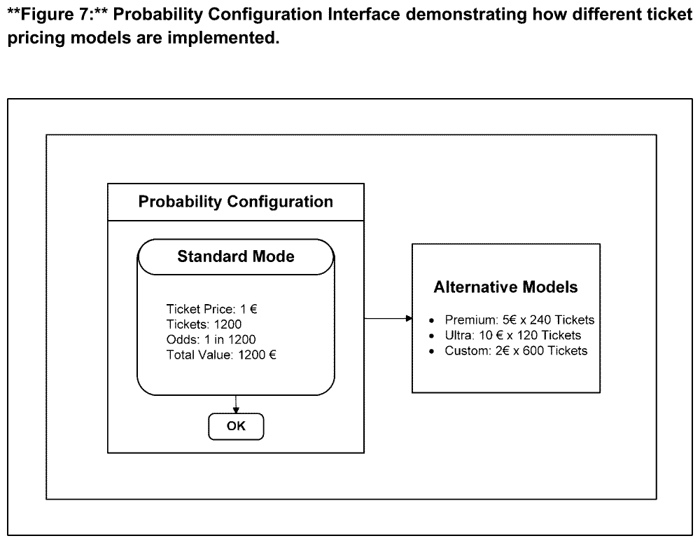

FIG. 7: Probability Configuration Interface demonstrating how different ticket pricing models are implemented.

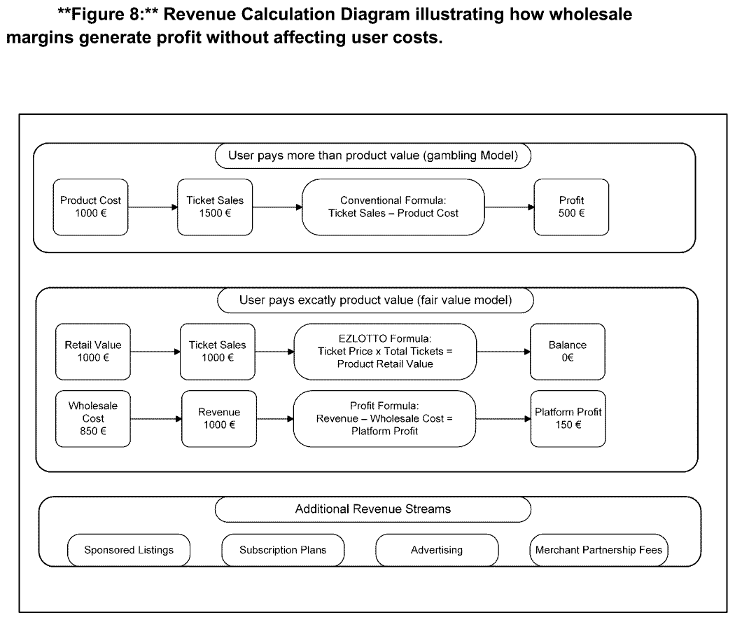

FIG. 8: Revenue Calculation Diagram illustrating how wholesale margins generate profit without affecting user costs.

The advantages of the invention include:
Mathematical Fairness: The system ensures that participants collectively pay exactly the market value of the product, never more, through strict enforcement of the fundamental value equation.
Legal Compliance: By avoiding cash prizes and maintaining transparent value equivalence, the system avoids classification as gambling in many jurisdictions, instead operating as a product distribution mechanism.
Dynamic Probability Structure: The system enables both mass-access raffles and high-odds raffles while maintaining price fairness through its configurable ticket pricing mechanism.
Ethical Revenue Generation: The business model relies on wholesale discounts and partnerships rather than extracting additional value from participants, maintaining integrity while ensuring business sustainability.
Trust-Building Mechanism: The automatic refund guarantee creates user confidence and long-term loyalty by ensuring participants never lose money on incomplete raffles.
Enhanced Security: The implementation of encryption, secure transaction processing, and fraud prevention measures protects both users and the platform operator.
Verifiable Fairness: The transparent randomization mechanism with cryptographic verification ensures that winners are selected through a demonstrably fair process.
Scalable Architecture: The system design allows for expansion across multiple markets, currencies, and product categories without compromising its core fairness principles.
Data Integrity: The digital ledger approach ensures all transactions are recorded immutably, creating an audit trail for regulatory compliance.
User Experience Focus: The intuitive interfaces and clear probability displays empower users to make informed decisions about participation.

All methods are protected under intellectual property law and part of a patent submission.

1. A computer-implemented method for conducting transparent digital raffles comprising:
Receiving input defining a product with a specified market value;
Calculating ticket quantity and price according to the formula: Ticket Price×Total Tickets=Product Value;
Implementing a ticket sales system that prevents selling more tickets than the defined quantity;
Executing a verifiable random selection process only after all tickets are sold;
Automatically refunding all participants if tickets are not sold within a defined timeframe.

2. The method of claim 1, wherein the system provides multiple probability configurations while maintaining the same total aggregate value.

3. The method of claim 1, wherein the random selection process utilizes a verifiable random function to ensure fair and transparent winner selection.

4. The method of claim 1, further comprising a secure digital ledger that records all ticket transactions with unique identifiers.

5. The method of claim 1, further comprising an automated notification system that alerts users to raffle status changes.

6. The method of claim 1, wherein the refund process includes verification steps to ensure all funds are returned to original payment methods.

7. The method of claim 1, further comprising a cryptographic verification system that generates proof of randomness for each draw.

8. A digital platform that implements the method of claims 1-7, comprising user interfaces, administrative tools, and automated processes for raffle management, random selection, and refund processing.

9. The platform of claim 8, wherein the system includes monitoring capabilities to ensure compliance with regional legal requirements.

10. The platform of claim 8, further comprising a multi-tier security system that protects user data and ensures transaction integrity.

11. The platform of claim 8, further comprising an analytic system that provides insights on raffle performance and user engagement.

12. The platform of claim 8, wherein the system includes a dynamic probability configuration tool that adjusts ticket prices and quantities while maintaining value equivalence.

13. The platform of claim 8, wherein the system implements a wholesale margin mechanism that calculates profitability based on acquisition cost versus market value.

14. The platform of claim 8, further comprising a sponsorship integration system that enables featured placement without affecting raffle integrity.

15. A method for ensuring fair digital raffles comprising:
Establishing a fixed product value as the total sum of all ticket sales;
Preventing overselling by implementing a strict ticket inventory control system;
Providing a transparent probability structure visible to all participants;
Executing draws only upon complete ticket sales;
Maintaining a cryptographically secure record of all transactions and draw results.

16. The method of claim 15, further comprising a time-limited cancellation mechanism that automatically terminates incomplete raffles.

17. The method of claim 15, wherein the probability structure includes multiple configurations that maintain the value equation while offering different odds.

18. The method of claim 15, wherein the system implements age verification and regional compliance checks before allowing participation.

19. In a raffle system where timing parameters are implemented, a method comprising:
Setting a maximum time period for ticket sales;
Monitoring ticket sales progress in real-time;
Triggering a draw immediately upon reaching total ticket sales regardless of remaining time;
Automatically canceling the raffle and processing refunds if the time period expires before all tickets are sold.

20. The method of claim 19, wherein the system maintains complete transaction records for all sales and refunds processed.
